(19) United States
(12) Patent Application Publication
(10) Pub. No.: US 2024/0429456 A1
(43) Pub. Date: Dec. 26, 2024

(54) ALL SOLID BATTERY

(71) Applicant: TAIYO YUDEN CO., LTD., Tokyo (JP)

(72) Inventors: Chie KAWAMURA, Tokyo (JP); Maki INOUE, Tokyo (JP)

(73) Assignee: TAIYO YUDEN CO., LTD., Tokyo (JP)

(21) Appl. No.: 18/692,591

(22) PCT Filed: Aug. 17, 2022
(86) PCT No.: PCT/JP2022/031078

§ 371 Date: Mar. 15, 2024

(30) Foreign Application Priority Data
Sep. 27, 2021 (JP) 2021-156728

(51) Int. Cl. H01M 10/0585

(52) U.S. Cl. CPC H01M 10/0585

(57) ABSTRACT

An all solid battery includes a multilayer body in which each of a plurality of electrode layers and each of a plurality of solid electrolyte layers are alternately stacked, wherein at least one of the plurality of electrode layers includes an end portion, a first portion in which a film thickness thereof increases at a first increase rate of 0.15 or more from the end portion to a first point, and a second portion in which the film thickness increases at a second increase rate of 0.1 or less from the first point to a second point, wherein the film thickness of the at least one of the plurality of electrode layers at the second point is a local maximum thickness and is 1.5 times or less as an average film thickness of the at least one of the plurality of electrode layers.

### TECHNICAL FIELD

The present invention relates to an all solid battery.

### BACKGROUND ART

In recent years, secondary batteries have been used in various fields. Secondary batteries using liquid electrolyte have problems such as electrolyte leakage. Therefore, all solid batteries are being developed that are equipped with a solid electrolyte and other components are also made of solid materials. All solid batteries have a structure in which solid electrolyte layers and internal electrode layers are alternately stacked, and can be expected to have high capacity and high responsiveness due to this structure.

However, if the solid electrolyte layer becomes thin, there is a risk that the upper and lower internal electrode layers may break through the solid electrolyte layer and cause a short circuit. For example, as in Patent Document 1, a protrusion is formed near the periphery of an internal electrode layer formed by screen printing due to the saddle phenomenon, but the protrusion may break the solid electrolyte layer and cause a short circuit.

In addition, the capacity can be adjusted by adjusting the width of the contact area between the internal electrode layer and the solid electrolyte layer (Patent Document 2), and reliability can be improved by making the ends of the internal electrode layer harder than the center (Patent Document 3). However, these proposals cannot sufficiently improve the reliability of all solid batteries.

### PRIOR ART DOCUMENT

### Patent Document

Patent Document 1: Japanese Patent Application Publication No. 2020-61433

Patent Document 2: Japanese Patent Application Publication No. 2015-220097

Patent Document 3: Japanese Patent Application Publication No. 2020-161235

### DISCLOSURE OF THE INVENTION

### Problems to be Solved by the Invention

The present invention has been made in view of the above problems, and aims to improve reliability of an all solid battery.

### Means for Solving the Problem

An all solid battery of the present invention includes a multilayer body in which each of a plurality of electrode layers and each of a plurality of solid electrolyte layers are alternately stacked, wherein at least one of the plurality of electrode layers includes an end portion, a first portion in which a film thickness thereof increases at a first increase rate of 0.15 or more from the end portion to a first point, and a second portion in which the film thickness increases at a second increase rate of 0.1 or less from the first point to a second point, wherein the film thickness of the at least one of the plurality of electrode layers at the second point is a local maximum thickness and is 1.5 times or less as an average film thickness of the at least one of the plurality of electrode layers.

In the above-mentioned all solid battery, the film thickness of the at least one of the plurality of electrode layers at the second point may be 1.2 times or less as the average film thickness.

In the above-mentioned all solid battery, the first increase rate may be 0.15 or more and 0.4 or less, and the second increase rate may be 0.03 or more and 0.09 or less.

In the above-mentioned all solid battery, the average film thickness of the at least one of the plurality of electrode layers may be 5 μm or more and 40 μm or less, and an average film thickness of each of the plurality of solid electrolyte layers may be 5 μm or more and 15 μm or less.

In the above-mentioned all solid battery, a distance between the end portion and the first point may be 40 μm or more and 60 μm or less, and a distance between the end portion and the second point may be 70 μm or more.

### Effects of the Invention

According to the present invention, it is possible to improve the reliability of the all solid battery.

### BRIEF DESCRIPTION OF THE DRAWINGS

FIG. 1 is an external view of an all solid battery;

FIG. 2 is a cross-sectional view taken along a line I-I in FIG. 1;

FIG. 3 is a cross-sectional view taken along a line II-II in FIG. 1;

FIG. 4A is an enlarged cross-sectional view of a first electrode layer in each of a section A and a section B of FIG. 3;

FIG. 4B is a cross-sectional view showing a definition of a first point; and

FIG. 5 illustrates a flowchart of a manufacturing method of an all solid battery.

### BEST MODES FOR CARRYING OUT THE INVENTION

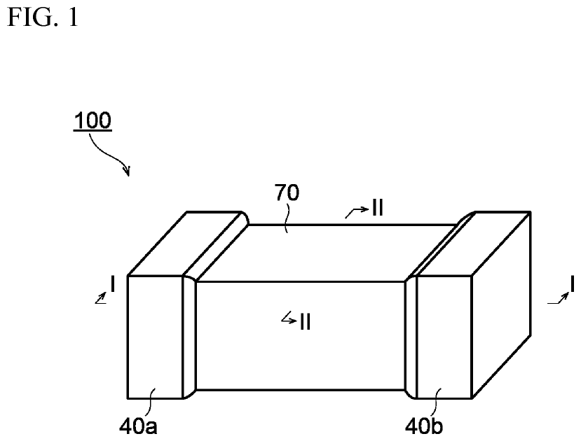

(Embodiment) FIG. 1 is an external view of an all solid battery 100. As illustrated in FIG. 1, the all solid battery 100 includes a multilayer chip 70 having a rectangular parallelepiped shape, and external electrodes 40a and 40b provided on two opposing surfaces of the multilayer chip 70.

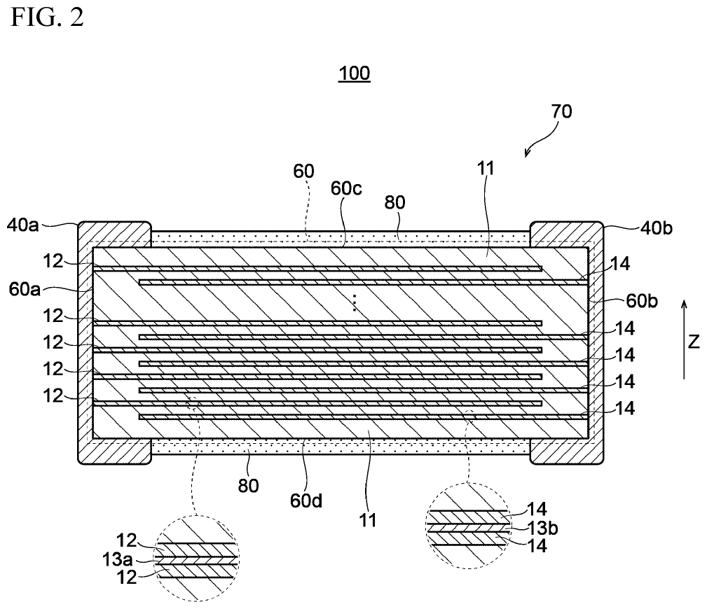

FIG. 2 is a cross-sectional view taken along a line I-I in FIG. 1. As illustrated in FIG. 2, the multilayer chip 70 includes a multilayer body 60 in which a plurality of solid electrolyte layers 11, a plurality of first electrode layers 12, and a plurality of second electrode layers 14 are stacked.

The multilayer body 60 has a first surface 60a and a second surface 60b that are parallel to the stacking direction Z of the first electrode layer 12 and the second electrode layer 14. The first external electrode 40a is provided on the first surface 60a, and the first electrode layer 12 is connected to the first external electrode 40a. On the other hand, the second external electrode 40b is provided on the second surface 60b, and the second electrode layer 14 is connected to the second external electrode 40b.

Furthermore, the multilayer body 60 has a third surface 60c and a fourth surface 60d that are parallel to each of the first electrode layer 12 and the second electrode layer 14. The third surface 60c is an upper surface that becomes the upper side when the all solid battery 100 is mounted on a wiring board. Further, the fourth surface 60d is a lower surface that becomes the lower side during mounting. In this example, the outermost layers of the multilayer body 60 are the solid electrolyte layers 11, and each of the third surface 60c and the fourth surface 60d is defined by the surface of the solid electrolyte layers 11.

Furthermore, both the first electrode layer 12 and the second electrode layer 14 are conductive layers containing both a positive electrode active material and a negative electrode active material. Although the positive electrode active material is not particularly limited, a material having an olivine crystal structure is used here as the positive electrode active material. Such a positive electrode active material includes, for example, a phosphate containing a transition metal and lithium. The olivine crystal structure is a crystal possessed by natural olivine, and can be determined by X-ray diffraction.

An example of an electrode active material having the olivine crystal structure is LiCoPO₄ containing Co. In this chemical formula, a phosphate or the like may be used in which the transition metal Co is replaced. Here, the ratio of Li and PO₄ may vary depending on the valence. Note that Co, Mn, Fe, Ni, or the like may be used as the transition metal.

Further, examples of the negative electrode active material include titanium oxide, lithium titanium composite oxide, lithium titanium composite phosphate, carbon, and lithium vanadium phosphate.

In this way, by using both the positive electrode active material and the negative electrode active material in each of the first electrode layer 12 and the second electrode layer 14, the similarity between the respective electrode layers 12 and 14 is increased. As a result, each of the first electrode layer 12 and the second electrode layer 14 comes to function as both a positive electrode and a negative electrode, and even if the terminals of the all solid battery 100 are attached with the positive and negative electrodes reversed, the all solid battery 100 can withstand actual use without malfunctioning during short-circuit testing. Note that this embodiment is not limited to this, and by forming a positive electrode layer as the first electrode layer 12 and a negative electrode layer as the second electrode layer 14, the all solid battery 100 may have polarity.

Furthermore, when producing the first electrode layer 12 and the second electrode layer 14, an oxide-based solid electrolyte material or a conductive aid such as carbon or metal may be added to these electrode layers. Examples of the metal of the conductive additive include Pd, Ni, Cu, and Fe. Furthermore, alloys of these metals may be used as conductive aids.

Furthermore, the layer structures of the first electrode layer 12 and the second electrode layer 14 are not particularly limited. For example, as illustrated with the dotted circle, the first electrode layer 12 may be formed on both main surfaces of a first current collector layer 13a made of a conductive material. Similarly, the second electrode layer 14 may be formed on both main surfaces of a second current collector layer 13b made of a conductive material.

On the other hand, as a material for the solid electrolyte layer 11, for example, there is a phosphate-based solid electrolyte having a NASICON structure. The phosphate solid electrolyte having the NASICON structure has high ionic conductivity and is chemically stable in the atmosphere. Although the phosphate-based solid electrolyte is not particularly limited, a phosphate containing lithium is used here. The phosphate is based on, for example, a composite lithium phosphate salt with Ti(LiTi₂(PO₄)₃), and trivalent transition metals such as Al, Ga, In, Y, and La are added to increase the Li content. Such a salt is Li—Al—M—PO₄ phosphates (M is Ge, Ti, Zr, or the like) such as Li₁₊ₓAlₓGe₂₋ₓ(PO₄)₃, Li₁₊ₓAlₓZr₂₋ₓ(PO₄)₃, Li₁₊ₓAlₓTi₂₋ₓ(PO₄)₃ or the like.

Furthermore, a Li—Al—Ge—PO₄-based phosphate to which a transition metal contained in the phosphate in the first electrode layer 12 has been added may be used as the material for the solid electrolyte layer 11. For example, when the first electrode layer 12 contains a phosphate containing either Co or Li, a Li—Al—Ge—PO₄-based phosphate to which Co has been added is added to the solid electrolyte layer 11. Thereby, it is possible to suppress elution of the transition metal from the first electrode layer 12 to the solid electrolyte layer 11.

Furthermore, a moisture-proof layer 80 is provided on the surface of the outermost solid electrolyte layer 11 of the multilayer body 60. The moisture-proof layer 80 is a layer of an inorganic oxide containing silicon, and serves to protect the multilayer body 60 from moisture in the atmosphere. Note that any one of B, Bi, Zn, Ba, Li, P, Sn, Pb, Mg, or Na may be added to the moisture-proof layer 80.

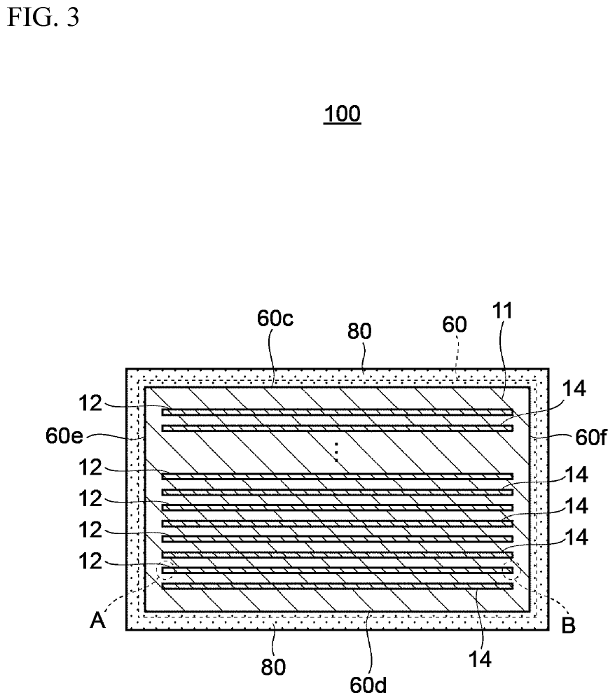

FIG. 3 is a cross-sectional view taken along a line II-II in FIG. 1. As illustrated in FIG. 3, the moisture-proof layer 80 is also provided on a fifth surface 60e and a sixth surface 60f of the multilayer body 60. The fifth surface 60e and the sixth surface 60f are perpendicular to each of the first electrode layer 12, the second electrode layer 14, the first surface 60a, and the second surface 60b, and are side surfaces when mounting the all solid battery 100 on a wiring board.

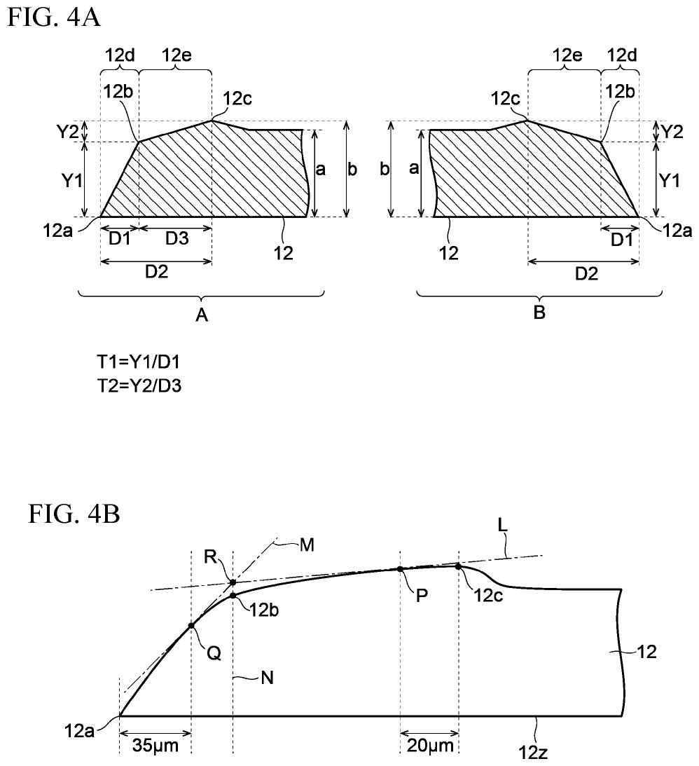

FIG. 4A is an enlarged cross-sectional view of the first electrode layer 12 in each of a section A and a section B of FIG. 3. As illustrated in FIG. 4A, the first electrode layer 12 includes an end portion 12a, a first portion 12d, and a second portion 12e. Among these, the first portion 12d is a portion where the film thickness increases at a first increase rate T1 from the end portion 12a to the first point 12b. The first increase rate T1 is defined as a ratio (Y1/D1) between the thickness Y1 of the first electrode layer 12 at the first point 12b and the first distance D1 in the in-plane direction between the end portion 12a and the first point 12b. Further, the first point 12b is a point where the slope of the side surface of the first electrode layer 12 changes.

In the example of FIG. 4A, the side surface of the first electrode layer 12 from the end portion 12a toward the first point 12b is linear in cross-sectional view, but the side surface may be curved outwardly. Similarly, the side surface of the first electrode layer 12 extending from the first point 12b to a second point 12c may have a curved shape that bulges outward in cross-sectional view. In this case, clear corners will not appear at the first point 12b and the second point 12c, and each point 12b, 12c will be rounded. FIG. 4B is a cross-sectional view showing the definition of the first point 12b in this case. In the example of FIG. 4B, a tangent M is drawn that passes through a point Q that is 35 μm away from the first point 12b in the in-plane direction. Next, a point P that is 20 μm apart in the in-plane direction from the second point 12c where the film thickness is maximum toward the first point 12b is specified, and a tangent L passing through the point P is drawn. Next, the intersection R of each of the tangents L and Mis specified, and a straight line N passing through the intersection R among the perpendicular lines to a bottom surface 12z of the first electrode layer 12 is determined. Then, the intersection of the straight line N and the upper surface of the first electrode layer 12 is defined as a first point 12b.

Referring again to FIG. 4A. The second portion 12e is a portion where the film thickness increases at a second increase rate T2 from the first point 12b to the second point 12c. The second increase rate T2 is defined as a ratio (Y2/D3) between the difference Y2 of the thickness of the first electrode layer between the second point 12c and the first point 12b and the third distance D3 between the second point 12c and the first point 12b in an in-plane direction.

In this embodiment, the first increase rate T1 is set to 0.15 or more, and the second increase rate T2 is set to 0.1 or less, so that T1>T2. More preferably, the first increase rate T1 is set to 0.2 or more, and the second increase rate T2 is set to 0.09 or less, so that T1>T2.

Furthermore, in one of the first electrode layers 12, the second point 12c is the point where the thickness of the first electrode layer 12 is locally maximum. In the following, the local maximum thickness of the first electrode layer 12 at the second point 12c will be written as “b”. Further, the average thickness of one of the first electrode layers 12 is written as “a”. In this embodiment, the ratio b/a is set to 1.5 or less. More preferably, the ratio b/a is 1.4 or less.

Note that in order to measure the average film thickness “a”, first, a cross section of the all solid battery 100 is subjected to CP processing, and the cross section is observed using an SEM at a magnification of 500 times to 1000 times. There are five observation fields. Then, the film thickness of the first electrode layer 12 at six locations within each observation field of view is measured, and the average value of the measured values at 30 locations is defined as the average film thickness “a”.

Furthermore, the first distance D1 between the end portion 12a and the first point 12b is 40 μm or more and 60 μm or less. By setting the first distance D1 to 40 μm or more in this way, the film thickness changes gradually from the end portion 12a to the first point 12b, so that the adhesion between the first electrode layer 12 and the solid electrolyte layer 11 at the end portion 12a improved, and peeling and cracking can be effectively suppressed. Furthermore, by setting the first interval D1 to 60 μm or less, the thin first electrode layer 12 existing from the end portion 12a to the first point 12b is reduced, increasing the capacity of the all solid battery 100. The second distance D2 between the end portion 12a and the second point 12c is 70 μm or more. This makes it difficult for peeling to occur at the interface between the first electrode layer 12 and the solid electrolyte layer 11, resulting in favorable cycle characteristics.

The average film thickness “a” of each of the electrode layers 12 and 14 is preferably 5 μm or more and 40 μm or less, and the average film thickness of the solid electrolyte layer 11 is preferably 5 μm or more and 20 μm or less. More preferably, the average film thickness “a” of each of the electrode layers 12, 14 is 8 μm or more and 35 μm or less, and the average film thickness of the solid electrolyte layer 11 is 8 μm or more and 15 μm or less. If the average film thickness “a” of each of the electrode layers 12, 14 is smaller than this range, the capacity of the all solid battery 100 will decrease, and conversely, if the average film thickness “a” is larger than this range, the rate characteristics will deteriorate. Furthermore, if the average thickness of the solid electrolyte layer 11 is smaller than the above range, short circuits are likely to occur, and conversely, if the average thickness of the solid electrolyte layer 11 is larger than the above range, the ion conduction path becomes longer and the rate characteristics deteriorate.

The aforementioned film thickness increase rates T1, T2 and respective widths D1, D2can be adjusted by the viscosity of the paste for each of the electrode layers 12, 14. Further, the average film thickness “a” and the local maximum film thickness “b” of each of the electrode layers 12, 14 can be controlled by the drying speed of the paste or by adding a leveling material to the paste.

The structure of the first electrode layer 12 is illustrated in FIG. 4A and FIG. 4B. The structure of the second electrode layer 14 is also the same as that of the first electrode layer 12.

According to the all solid battery 100, as described above, the first increase rate T1 is 0.15 or more and the second increase rate T2 is 0.1 or less, so that T1>T2.

As a result, the thickness of the first electrode layer 12 increases gradually the location becomes away from the end portion 12a. By gradually increasing the film thickness in this way, even if the film thickness of the first electrode layer 12 changes with charging and discharging, the stress that the solid electrolyte layer 11 receives from the first electrode layer 12 is alleviated. Therefore, generation of cracks between the solid electrolyte layer 11 and the first electrode layer 12 can be suppressed. For the same reason, generation of cracks between the solid electrolyte layer 11 and the second electrode layer 14 can also be suppressed.

Furthermore, by setting the ratio b/a of the local maximum film thickness “b” to the average film thickness “a” of the first electrode layer 12 to be 1.5 or less, the sharpness of the first electrode layer 12 at the second point 12c becomes gentle. Therefore, it is possible to suppress the second point 12c from breaking through the solid electrolyte layer 11 and contacting the second electrode layer 14 thereon, and it is possible to suppress short-circuiting between the electrode layers 12 and 14.

As a result, the present embodiment can provide a highly reliable all solid battery 100 in which the occurrence of cracks and short circuits is suppressed.

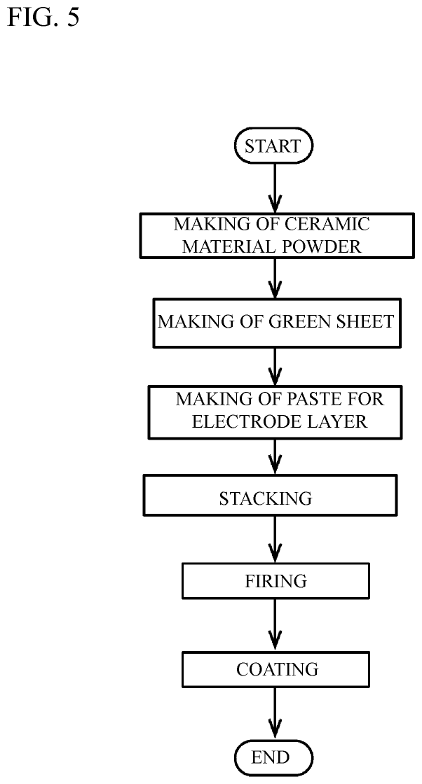

Next, a method for manufacturing the all solid battery according to this embodiment will be described. FIG. 5 is a flowchart of the method for manufacturing the all solid battery according to this embodiment.

(Ceramic raw material powder production process) First, a phosphate-based solid electrolyte powder that constitutes the solid electrolyte layer 11 described above is produced. For example, the phosphate-based solid electrolyte powder that constitutes the solid electrolyte layer 11 can be produced by mixing raw materials and additives and using a solid phase synthesis method. By dry-pulverizing the obtained powder, it is possible to adjust the powder to a desired average particle size. For example, the particles are adjusted to a desired average particle size using a planetary ball mill using ZrO₂ balls of 5 mm diameter.

Additives include sintering aids. As the sintering aid, for example, any one of glass component such as Li—B—O based compounds, Li—Si—O based compounds, Li—C—O based compounds, Li—S—O based compounds, and Li—P—O based compounds can be used.

(Green sheet production process) Next, the obtained powder is uniformly dispersed in an aqueous or organic solvent together with a binder, a dispersant, a plasticizer and so on and wet pulverized to form a solid electrolyte slurry having a desired average particle size. At this time, a bead mill, a wet jet mill, various kneading machines, a high-pressure homogenizer or the like can be used, and it is preferable to use a bead mill from the viewpoint of being able to adjust the particle size distribution and perform dispersion at the same time.

Then, a binder is added to the obtained solid electrolyte slurry to obtain a solid electrolyte paste. By applying the solid electrolyte paste, a green sheet for the solid electrolyte layer 11 is obtained. The coating method is not particularly limited, and a slot die method, reverse coating method, gravure coating method, bar coating method, doctor blade method or the like can be used. The particle size distribution after wet pulverization can be measured using, for example, a laser diffraction measuring device using a laser diffraction scattering method.

(Paste production process for electrode layer) Next, an electrode layer paste for producing the first electrode layer 12 and the second electrode layer 14 is produced. For example, a positive electrode active material, a negative electrode active material, and a solid electrolyte material are highly dispersed using a bead mill or the like to produce a ceramic paste consisting only of ceramic particles. Alternatively, a carbon paste containing carbon particles such as carbon black may be prepared and the carbon paste may be kneaded with ceramic paste.

(Stacking process) Next, the electrode layer paste is printed on one main surface of the green sheet. Next, a plurality of printed green sheets are alternately shifted and stacked, and then cut into a predetermined size with a dicer to obtain the multilayer body 60. Note that the uppermost layer and the lowermost layer of the multilayer body 60 are green sheets.

(Firing process) Next, the multilayer body 60 is fired in a firing atmosphere containing oxygen. In order to suppress the disappearance of the carbon material contained in the electrode layer paste, it is preferable that the oxygen partial pressure of the firing atmosphere is 2×10⁻¹³ atm or less. On the other hand, in order to suppress melting of the phosphate solid electrolyte, the oxygen partial pressure is preferably set to 5×10⁻²² atm or more.

Thereafter, the first external electrode 40a and the second external electrode 40b are formed by applying a metal paste to each of the surfaces 60a, 60b of the multilayer body 60 and baking the metal paste. Note that the first external electrode 40a and the second external electrode 40b may be formed by a sputtering method or a plating method.

(Coating process) Next, a solution of tetraalkoxysilane dissolved in dibutyl ether or a dibutyl ether-based solvent is applied to the third to sixth surfaces 60c to 60f of the multilayer body 60. Thereafter, the moisture-proof layer 80 is obtained by heating the solution to a temperature of about 100° C. to 150° C. Through the above steps, the basic structure of the all solid battery 100 is fabricated.

### Example

All solid batteries according to Examples 1 to 4 and Comparative Examples 2 to 3 were manufactured as follows. Table 1 is a table summarizing the shapes of the electrode layers 12 and 14 in each of Examples 1 to 4 and Comparative Examples 2 to 3.

TABLE 1

| | AVERAGE FILM | AVERAGE FILM | INCREASE RATE | | DISTANCE | | | |
|---|---|---|---|---|---|---|---|---|
| | THICKNESS | THICKNESS a | OF FILM THICKNESS | | (μm) | | LOCAL MAXIMUM | |
| | OF SOLID | OF | FIRST | SECOND | FIRST | SECOND | FILM THICKNESS b | |
| | ELECTROLYTE | ELECTRODE | INCREASE | INCREASE | DISTANCE | DISTANCE | OF ELECTRODE | |
| | LAYER | LAYER | RATE T1 | RATE T2 | D1 | D2 | LAYER | b/a |
| EXAMPLE 1 | 5 | 5 | 0.15 | 0.05 | 40 | 70 | 7.5 | 1.5 |
| EXAMPLE 2 | 10 | 30 | 0.3 | 0.1 | 58 | 244 | 36 | 1.2 |
| EXAMPLE 3 | 15 | 40 | 0.2 | 0.09 | 60 | 416 | 44 | 1.1 |
| EXAMPLE 4 | 5 | 5 | 0.15 | 0.03 | 40 | 73 | 7 | 1.4 |
| COMPARATIVE | 5 | 15 | 0.4 | 0.13 | 40 | 71 | 20 | 1.3 |
| EXAMPLE 1 | | | | | | | | |
| COMPARATIVE | 5 | 5 | 0.15 | 0.08 | 40 | 71 | 8.5 | 1.7 |
| EXAMPLE 2 | | | | | | | | |
| COMPARATIVE | 4 | 4 | 0.12 | 0.02 | 40 | 100 | 6 | 1.5 |
| EXAMPLE 3 | | | | | | | | |

(Example 1) First, Co₃O₄, Li₂CO₃ , ammonium dihydrogen phosphate, Al₂O₃, and GeO₂ were mixed to produce Li_{1.3}Al_{0.3}Ge_{1.7}(PO₄)₃ containing a predetermined amount of Co as a solid electrolyte material powder by solid phase synthesis. The obtained powder was dry-pulverized using ZrO₂ balls. Furthermore, a solid electrolyte slurry was prepared by wet pulverization using ion-exchanged water or ethanol as a dispersion medium. A binder was added to the obtained slurry to obtain a solid electrolyte paste, and a green sheet was produced. Li_{1.3}Al_{0.3}Ti_{1.7}(PO₄)₃ containing a predetermined amount of LiCoPO₄ and Co was synthesized by the solid phase synthesis method in the same manner as above.

In Example 1, a positive electrode active material, a negative electrode active material, and a solid electrolyte material were highly dispersed using a wet bead mill or the like to produce a ceramic paste consisting only of ceramic particles. Next, the ceramic paste and the conductive additive were thoroughly mixed to produce an electrode layer paste for producing the first electrode layer 12 and the second electrode layer 14.

Note that LiCoPO₄ was used as the positive electrode active material. Li₁₊ₓAlₓTi₂₋ₓ(PO₄)₃ was used as the negative electrode active material.

An electrode layer paste was printed on the green sheet using a screen printing method. After printing, 10 green sheets were stacked with the electrodes being shifted from side to side so that the electrodes were drawn out. Thereafter, the green sheets were pressed together using a hot press, and each green sheet was cut using a dicer to obtain the multilayer body 60 of a predetermined size.

The multilayer body 60 was heat-treated at 300° C. or higher and 500° C. or lower to degrease the multilayer body 60, and then heat-treated at 900° C. or lower for sintering. Thereafter, the first external electrode 40a and the second external electrode 40b were formed on each of the surfaces 60a, 60b of the multilayer body 60.

Next, a solution of tetraalkoxylan dissolved in dibutyl ether was applied to the third to sixth surfaces 60c to 60f of the multilayer body 60. A silica layer was formed as the moisture-proof layer 80 by heating the solution to 200° C. or more and 500° C. or less.

The average thickness of the solid electrolyte layer 11 of the completed all solid battery was 5 μm, and the average thickness a of each of the electrode layers 12 and 14 was 5 μm.

Further, the first increase rate T1 of the film thickness of each of the electrode layers 12, 14 was 0.15, and the second increase rate T2 was 0.05. Furthermore, the first distance D1 in each of the electrode layers 12, 14 was 40 μm, and the second distance D2 was 70 μm. The local maximum film thickness “b” of each of the electrode layers 12 and 14 was 7.5 μm. Further, the ratio b/a between the local maximum film thickness “b” and the average film thickness “a” in each of the electrode layers 12 and 14 was 1.5.

(Example 2) In Example 2, the average thickness of the solid electrolyte layer 11 was 10 μm, and the average thickness “a” of each of the electrode layers 12 and 14 was 30 μm.

Further, the first increase rate T1 of the film thickness of each of the electrode layers 12, 14 was 0.3, and the second increase rate T2 was 0.1. Furthermore, the first distance D1 in each of the electrode layers 12, 14 was 58 μm, and the second distance D2 was 244 μm. The local maximum film thickness “b” of each of the electrode layers 12 and 14 was 36 μm. Further, the ratio b/a between the local maximum film thickness “b” and the average film thickness “a” in each of the electrode layers 12 and 14 was 1.2. The rest is the same as in Example 1.

(Example 3) In Example 3, the average thickness of the solid electrolyte layer 11 was 15 μm, and the average thickness “a” of each of the electrode layers 12, 14 was 40 μm.

Further, the first increase rate T1 of the film thickness of each of the electrode layers 12, 14 was 0.2, and the second increase rate T2 was 0.09. Furthermore, the first distance D1 in each of the electrode layers 12, 14 was 60 μm, and the second distance D2 was 416 μm. The local maximum thickness “b” of each of the electrode layers 12, 14 was 44 μm. Furthermore, the ratio b/a between the local maximum film thickness “b” and the average film thickness “a” in each of the electrode layers 12, 14 was 1.1. The rest is the same as in Example 1.

(Example 4) In Example 4, the average thickness of the solid electrolyte layer 11 was 5 μm, and the average thickness “a” of each of the electrode layers 12 and 14 was 5 μm.

Further, the first increase rate T1 of the film thickness of each of the electrode layers 12, 14 was 0.15, and the second increase rate T2 was 0.03. Furthermore, the first distance D1 in each of the electrode layers 12, 14 was 40 μm, and the second distance D2 was 73 μm. The local maximum film thickness “b” of each of the electrode layers 12, 14 was 7 μm. Furthermore, the ratio b/a between the local maximum film thickness “b” and the average film thickness “a” in each of the electrode layers 12 and 14 was 1.4. The rest is the same as in Example 1.

(Comparative Example 1) In Comparative Example 1, the average thickness of the solid electrolyte layer 11 was 5 μm, and the average thickness “a” of each of the electrode layers 12, 14 was 15 μm.

Further, the first increase rate T1 of the film thickness of each of the electrode layers 12, 14 was 0.4, and the second increase rate T2 was 0.13. Furthermore, the first distance D1 in each of the electrode layers 12, 14 was 40 μm, and the second distance D2 was 71 μm. The local maximum film thickness “b” of each of the electrode layers 12, 14 was 20 μm. Further, the ratio b/a between the local maximum film thickness “b” and the average film thickness “a” in each of the electrode layers 12, 14 was 1.3. The rest is the same as in Example 1.

(Comparative Example 2) In Comparative Example 2, the average thickness of the solid electrolyte layer 11 was 5 μm, and the average thickness “a” of each of the electrode layers 12, 14 was 5 μm.

Further, the first increase rate T1 of the film thickness of each of the electrode layers 12, 14 was 0.15, and the second increase rate T2 was 0.08. Furthermore, the first distance D1 in each of the electrode layers 12, 14 was 40 μm, and the second distance D2 was 71 μm. The local maximum film thickness “b” of each of the electrode layers 12, 14 was 8.5 μm. Furthermore, the ratio b/a between the local maximum film thickness “b” and the average film thickness “a” in each of the electrode layers 12, 14 was 1.7. The rest is the same as in Example 1.

(Comparative Example 3) In Comparative Example 3, the average thickness of the solid electrolyte layer 11 was 4 μm, and the average thickness “a” of each of the electrode layers 12, 14 was 4 μm.

Further, the first increase rate T1 of the film thickness of each of the electrode layers 12, 14 was 0.12, and the second increase rate T2 was 0.02. Furthermore, the first distance D1 in each of the electrode layers 12, 14 was 40 μm, and the second distance D2 was 100 μm. The local maximum film thickness “b” of each of the electrode layers 12, 14 was 6 μm. Further, the ratio b/a between the local maximum film thickness “b” and the average film thickness “a” in each of the electrode layers 12, 14 was 1.5. The rest is the same as in Example 1.

Next, the characteristics of the all solid battery were investigated for each Example and Comparative Example. The results are shown in Table 2.

TABLE 2

| | | CYCLE | | SHORT | | |
|---|---|---|---|---|---|---|
| | INTERFACE | CHARACTERISTICS | | RATE | | TARGET VALUE |
| | PEELING | (%) | JUDGE | (%) | JUDGE | OF CAPACITY |
| EXAMPLE 1 | NONE | 91 | ⊚ | 15 | Δ | ◯ |
| EXAMPLE 2 | NONE | 71 | Δ | 5 | ⊚ | ◯ |
| EXAMPLE 3 | NONE | 83 | ◯ | 1 | ⊚ | ◯ |
| EXAMPLE 4 | NONE | 85 | ◯ | 6 | ◯ | Δ |
| COMPARATIVE | EXIST | 66 | X | 8 | ◯ | ◯ |
| EXAMPLE 1 | | | | | | |
| COMPARATIVE | NONE | 90 | ⊚ | 18 | X | — |
| EXAMPLE 2 | | | | | | |
| COMPARATIVE | NONE | 88 | ◯ | 17 | X | — |
| EXAMPLE 3 | | | | | | |

In this investigation, each of the all solid batteries of Examples 1 to 4 and Comparative Examples 1 to 3 was examined for the presence or absence of interfacial peeling, cycle characteristics, short-circuit rate, and whether target capacity values were obtained. Among these, the presence or absence of interfacial peeling was determined as “present” if there was peeling at the interface between the first electrode layer 12 and the solid electrolyte layer 11 or the interface between the second electrode layer 14 and the solid electrolyte layer 11, if there was no peeling, it was judged as “none”.

In addition, the cycle characteristics are defined as (200th discharge capacity/first discharge capacity) when charging and discharging at 10 C are repeated in a voltage range of 2.5 V to 0 V at 25° C. A case where the cycle characteristic was 90% or more was evaluated as “double circle”, a case of 80% to 90% was evaluated as “○”, a case of 70% to 80% was evaluated as “Δ”, and a case of less than 70% was evaluated as “x”. The short-circuit rate was calculated by producing 200 samples of all solid batteries of Examples 1 to 4 and Comparative Examples 1 to 3 as (number of short-circuited batteries)/200. Further, the short ratio was evaluated as “double circle” when short-circuit rate was 5% or less, “○” when the short-circuit rate was 10% or less, “Δ” when the short-circuit rate was 15% or less, and “x” when the short-circuit rate was less than 15%.

The target capacity value was determined as a theoretical value with the electrode shape as a rectangular parallelepiped, and when that value was set as 100%, the capacity value of 95% or more was evaluated as “○”, and evaluated as “Δ” when the capacity value was less than 95%. In addition, if the evaluation could not be made due to short circuit, it was evaluated as “-”.

If there is no interfacial peeling and the evaluation of either cycle characteristics or short-circuit rate is not “x”, the reliability of the all solid battery is high.

As shown in Table 2, in Examples 1 to 4, there was no interfacial peeling, and the short-circuit rate was not “x”. This result shows that setting the first increase rate T1 to 0.15 or more and setting the second increase rate T2 to 0.1 or less as in Examples 1 to 4 is effective in suppressing interfacial peeling.

Furthermore, in Examples 1 to 4, the ratio b/a was set to 1.5 or less, and it was confirmed that this improved the short-circuit rate.

In particular, in Examples 1 to 4, the average film thickness “a” of each of the electrode layers 12, 14 is 5 μm or more and 40 μm or less, and the average film thickness of the solid electrolyte layer 11 is 5 μm or more and 15 μm or less. In this case, by setting the first distance D1 to 40 μm or more and 60 μm or less and setting the second distance D2 to 70 μm or more as in Examples 1 to 4, interfacial peeling and short circuits can be effectively suppressed.

Furthermore, it was revealed that in Examples 2 and 3 where the ratio b/a was set to 1.2 or less, the short rate determination result was “double circle”.

Furthermore, in Examples 1, 3, and 4 in which the first increase rate T1 is 0.15 or more and 0.2 or less and the second increase rate T2 is 0.03 or more and 0.09 or less, it becomes clear that the cycle characteristic determination results is greater than or equal to “○”.

Although the embodiments of the present invention have been described in detail, it is to be understood that the various change, substitutions, and alterations could be made hereto without departing from the spirit and scope of the invention.

1. An all solid battery comprising:
a multilayer body in which each of a plurality of electrode layers and each of a plurality of solid electrolyte layers are alternately stacked,
wherein at least one of the plurality of electrode layers includes an end portion, a first portion in which a film thickness thereof increases at a first increase rate of 0.15 or more from the end portion to a first point, and a second portion in which the film thickness increases at a second increase rate of 0.1 or less from the first point to a second point,
wherein the film thickness of the at least one of the plurality of electrode layers at the second point is a local maximum thickness and is 1.5 times or less as an average film thickness of the at least one of the plurality of electrode layers,
wherein an intersection of a straight line N and an upper surface of the at least one of the plurality of electrode layers is defined as the first point. when a tangent M is drawn that passes through a point Q that is 35 μm away from the end portion in an in-plane direction, a point P that is 20 μm apart in the in-plane direction from the second point where the film thickness is maximum toward the first point is specified, a tangent L passing through the point P is drawn, an intersection R of each of the tangents L and M is specified, and the straight line N passing through the intersection R among perpendicular lines to a bottom surface of the at least one of the plurality of electrode layers is determined.

2. The all solid battery as claimed in claim 1, wherein the film thickness of the at least one of the plurality of electrode layers at the second point is 1.2 times or less as the average film thickness.

3. The all solid battery as claimed in claim 1, wherein:
the first increase rate is 0.15 or more and 0.4 or less; and
the second increase rate is 0.03 or more and 0.09 or less.

4. The all solid battery as claimed in claim 1, wherein:
the average film thickness of the at least one of the plurality of electrode layers is 5 μm or more and 40 μm or less; and
an average film thickness of each of the plurality of solid electrolyte layers is 5 μm or more and 15 μm or less.

5. The all solid battery as claimed in claim 1, wherein:
a distance between the end portion and the first point is 40 μm or more and 60 μm or less; and
a distance between the end portion and the second point is 70 μm or more.
